(19) United States
(12) Patent Application Publication
(10) Pub. No.: US 2019/0052369 A1
(43) Pub. Date: Feb. 14, 2019

(54) TECHNIQUES FOR HIGH SPEED OPTOELECTRONIC COUPLING BY REDIRECTION OF OPTICAL PATH

(71) Applicant: MACOM Technology Solutions Holdings, Inc., Lowell, MA (US)

(72) Inventors: Xian-Li YEH, Walnut, CA (US); Cecile V. COHEN-JONATHAN, Saratoga, CA (US); Boris GREK, Hayward, CA (US); C. Jacob SUN, Saratoga, CA (US)

(73) Assignee: MACOM Technology Solutions Holdings, Inc., Lowell, MA (US)

(21) Appl. No.: 15/887,454

(22) Filed: Feb. 2, 2018

Related U.S. Application Data
(60) Provisional application No. 62/542,495, filed on Aug. 8, 2017.

(51) Int. Cl. H04B 10/66; G02B 19/00

(52) U.S. Cl. CPC H04B 10/66; G02B 19/0076; G02B 19/0009

(57) ABSTRACT

Techniques for high speed optoelectronic coupling by redirection of optical path are disclosed. In one particular embodiment, the techniques may be realized as an optoelectronic receiver comprising an optical signal demultiplexer that may be configured to transmit an optical signal along a first axis, and a photodiode that may be configured to convert the optical signal into an electrical signal, wherein the optical signal demultiplexer may include an inclined end surface that may be configured to reflect the optical signal towards a photoactive area of the photodiode at an obtuse angle of reflection with respect to the first axis.

### CROSS-REFERENCE TO RELATED APPLICATIONS

This patent application claims priority to U.S. Provisional Patent Application No. 62/542,495, filed Aug. 8, 2017, which is hereby incorporated by reference herein in its entirety.

### FIELD OF THE DISCLOSURE

The present disclosure generally relates to optoelectronic coupling, and more particularly, to techniques for high speed optoelectronic coupling to optoelectronic receivers.

### BACKGROUND OF THE DISCLOSURE

Optoelectronic receivers can be an important component of modern optical communications systems. Optoelectronic receivers may operate to extract a baseband signal from a modulated optical carrier signal by converting the optical signal into an electric signal.

Optoelectronic receivers may be housed in a flat, cuboid-shaped housing, such as that shown in FIG. 1, and may receive an optical signal through one side of the housing. An electrical signal may be output through the opposite side of the housing via an RF feedthrough. Thus, the optical signal path and the electrical signal path may be collinear. A receiver design may have a 90 degree bend in its electrical signal path, which may create an imperfect impedance line.

In view of the foregoing, it may be understood that there may be significant problems and shortcomings associated with current optoelectronic receivers. Optoelectronic receivers that improve upon the shortcomings associated with the current optoelectronic receivers may be desired.

### SUMMARY OF THE DISCLOSURE

Techniques for high speed optoelectronic coupling by redirection of optical path are disclosed. In one particular embodiment, the techniques may be realized as an optoelectronic receiver comprising an optical signal demultiplexer that may be configured to transmit an optical signal along a first axis, and a photodiode that may be configured to convert the optical signal into an electrical signal, wherein the optical signal demultiplexer may include an inclined end surface that may be configured to reflect the optical signal towards a photoactive area of the photodiode at an obtuse angle of reflection with respect to the first axis.

In accordance with other aspects of this particular embodiment, the optical signal may include multiple wavelengths of light.

In accordance with other aspects of this particular embodiment, the optical signal may include a single wavelength of light.

In accordance with other aspects of this particular embodiment, the optical signal may be a modulated optical carrier signal.

In accordance with other aspects of this particular embodiment, the optical signal demultiplexer may be configured to demultiplex the optical signal into a plurality of optical signals that each have a different wavelength of light.

In accordance with other aspects of this particular embodiment, the photodiode may be configured to convert the optical signal into a radio frequency (RF) signal.

In accordance with other aspects of this particular embodiment, the RF signal may be output via an RF feedthrough.

In accordance with other aspects of this particular embodiment, the photodiode may include at least one lens configured to focus the optical signal toward the photoactive area of the photodiode.

In accordance with other aspects of this particular embodiment, the optical signal demultiplexer may be an arrayed waveguide demultiplexer.

In accordance with other aspects of this particular embodiment, the obtuse angle of reflection may be about 98 degrees.

In accordance with other aspects of this particular embodiment, an angle of the inclined end surface may be less than or equal to about 90°−ArcSin [1×Sin(90°)/n_{WG}], where n_{WG} may be the refractive index of a waveguide material of the optical signal demultiplexer.

In another particular embodiment, the techniques may be realized as an optoelectronic receiver comprising an optical signal demultiplexer that may be configured to transmit an optical signal along a first axis, a photodiode that may be configured to convert the optical signal into an electrical signal, and a reflector that may have an inclined surface that may be configured to reflect the optical signal towards a photoactive area of the photodiode at an obtuse angle of reflection with respect to the first axis.

In accordance with other aspects of this particular embodiment, the optical signal may include multiple wavelengths of light.

In accordance with other aspects of this particular embodiment, the optical signal may include a single wavelength of light.

In accordance with other aspects of this particular embodiment, the optical signal may be a modulated optical carrier signal.

In accordance with other aspects of this particular embodiment, the optical signal demultiplexer may be configured to demultiplex the optical signal into a plurality of optical signals that each have a different wavelength of light.

In accordance with other aspects of this particular embodiment, the photodiode may be configured to convert the optical signal into a radio frequency (RF) signal.

In accordance with other aspects of this particular embodiment, the RF signal may be output via an RF feedthrough.

In accordance with other aspects of this particular embodiment, the photodiode may include at least one lens configured to focus the optical signal toward the photoactive area of the photodiode

In accordance with other aspects of this particular embodiment, the optical signal demultiplexer may be an arrayed waveguide demultiplexer.

In accordance with other aspects of this particular embodiment, the obtuse angle of the reflection may be about 98 degrees.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a top view of an example optoelectronic receiver having a flat, cuboid housing.

FIG. 2 illustrates a cross-sectional view of the optoelectronic receiver of FIG. 1, along the dotted line I-I, according to a traditional implementation.

FIG. 3 shows an optoelectronic receiver according to an embodiment of the present disclosure.

FIG. 4 shows an optoelectronic receiver according to an embodiment of the present disclosure.

FIG. 5 shows an optoelectronic receiver according to an embodiment of the present disclosure.

### DETAILED DESCRIPTION OF EMBODIMENTS

The present disclosure and the related advantages are described and highlighted in the following description and accompanying figures which are not necessarily drawn to scale. Detailed descriptions of some structure and processing techniques are omitted so as to not unnecessarily obscure the present disclosure.

Each of the features and teachings disclosed herein may be utilized separately or in conjunction with other features and teachings to provide the present system and method. Representative examples utilizing many of these features and teachings, both separately and in combination, are described with reference to the attached figures. While the detailed description herein illustrates to a person of ordinary skill in the art further details for practicing aspects of the present teachings, it does not limit the scope of the claims. Therefore, combinations of features disclosed in the detailed description are representative examples of the present teachings and may not be necessary to practice the teachings in the broadest sense.

Relative terms, such as “top,” “bottom,” “left,” “right,” etc., may be used herein to describe the spatial relations of components shown in the figures. As such, when used in such context, these terms should be construed in accordance with the spatial orientation of the components as depicted in the relevant figures and not as absolute terms.

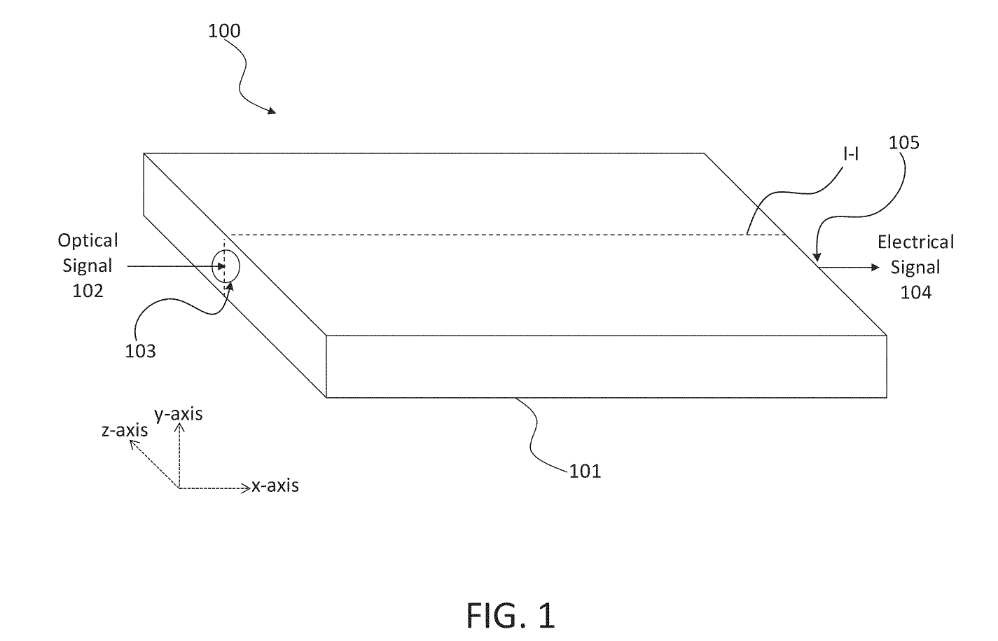

FIG. 1 shows an optoelectronic receiver 100 housed in a flat, cuboid-shaped housing 101. An optical signal 102 may be received by receiver 100 at input 103. The optical signal may be manipulated by components of optoelectronic receiver 100, such that an electrical signal 104 is output by receiver 100. Electrical signal 104 may be output via an output device 105 of receiver 100. Output device 105 may be an RF feedthrough, for example. The electrical signal path of receiver 100 may include a sharp bend. This sharp bend may create an imperfect impedance path.

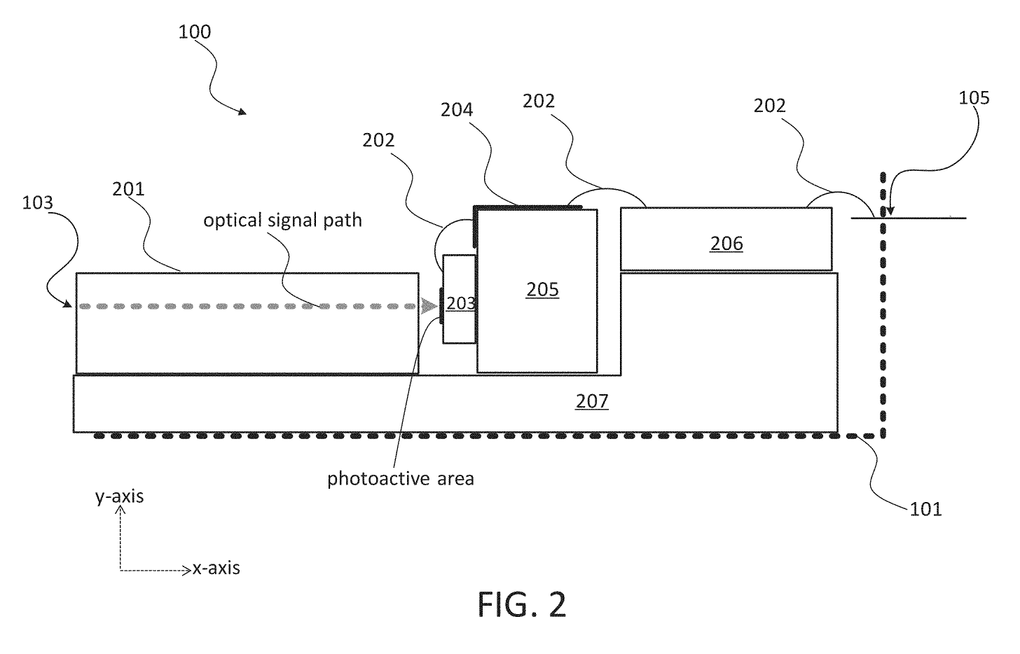

FIG. 2 illustrates a cross-sectional view of the optoelectronic receiver 100 along the dotted line I-I shown in FIG. 1. Optoelectronic receiver 100 includes an input 103, arrayed wave guide demultiplexer (AWG DEMUX) 201 for demultiplexing multiwavelength signals, photodiode 203, a bent RF path 204, a dielectric sub-mount 205, a transimpedance amplifier (TIA) 206, a bench 207, and output device 105, all of which are housed by housing 101. Housing 101 is partially shown in FIG. 2 for ease of viewing. AWG DEMUX 201 may be used to demultiplexing an optical signal 102 that includes multiple wavelengths.

Photodiode 203, the RF signal path 204, the TIA 206, and the output device 105 are electrically connected via wires 202. Output device 105 may be an RF feedthrough, for example. Photodiode 203 may be a surface illuminated photodiode in a box-type package, for example. Surface illuminated photodiodes may be used in receivers that handle data rates up to 25 Gb/s. The use of surface illuminated photodiodes may reduce manufacturing cost and may increase optical coupling alignment tolerance.

The optical signal that is output by AWG DEMUX 201 couples directly to the vertically mounted photodiode 203, as shown by FIG. 2. Photodiode 203 outputs an electrical signal, which may be an RF signal. The output signal is bent 90 degrees via bent RF path 204. Bent RF path 204 may be a ceramic substrate with wraparound RF traces. RF path 204 is wire bonded to TIA 206.

The bent RF path 204 is used because the photoactive area (optical input plane) of photodiode 203 is perpendicular to the output end of wire 202 connected to photodiode 203. When the data rate is 25 Gb/s or higher, the sharp bending of the bent RF signal 204 path may degrade receiver sensitivity due to imperfect impedance line.

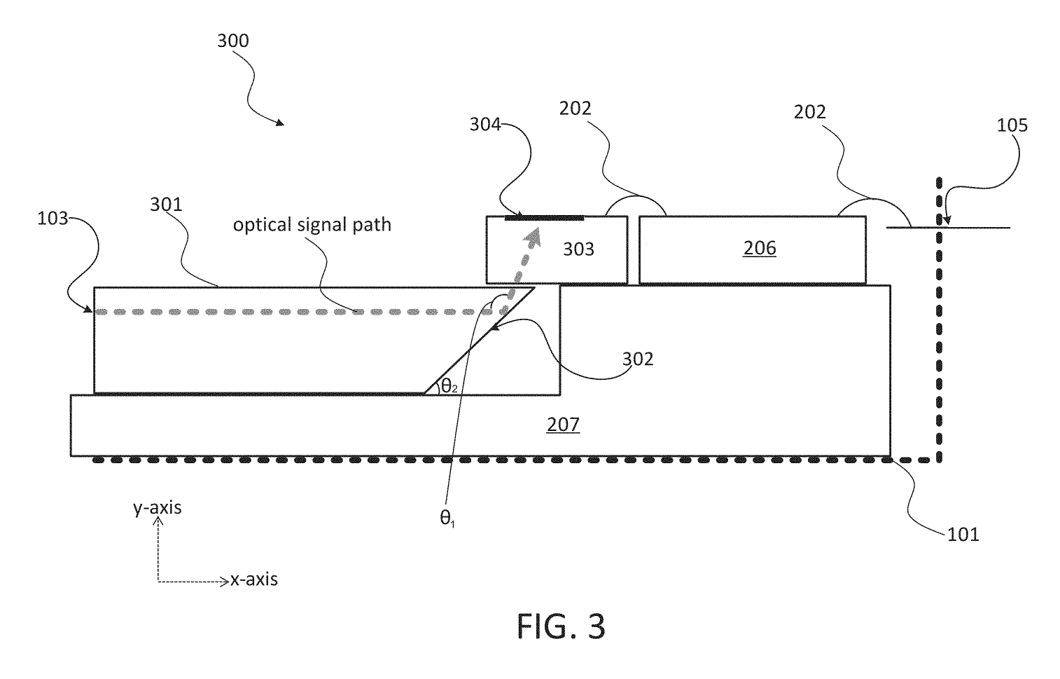

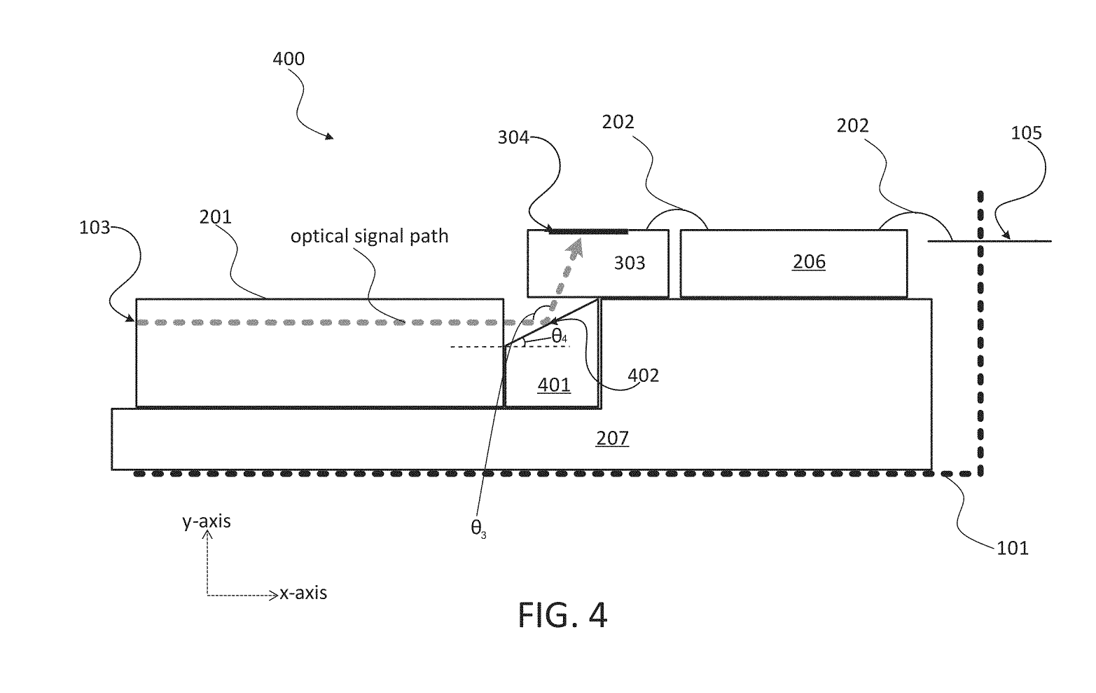

Optoelectronic receivers according to embodiments of the present disclosure do not include a bent RF path. Rather, optoelectronic receivers according to embodiments of the present disclosure reflect the optical signal towards the photodiode at an obtuse angle of reflection with respect to an initial optical signal path. FIG. 3 and FIG. 4 show exemplary optoelectronic receivers according to embodiments of the present disclosure. However, the present system and method are not limited to these embodiments and may include various other embodiments that reflect or otherwise redirect the optical signal towards the photodiode instead of bending the RF signal path.

FIG. 3 shows an optoelectronic receiver 300 in accordance with embodiments of the present disclosure. Optoelectronic receiver 300 may include an input 103, arrayed wave guide demultiplexer (AWG DEMUX) 301, photodiode 303, TIA 206, bench 207, and output device 105, which are housed by housing 101. Housing 101 is partially shown in FIG. 3 for ease of viewing.

An optical signal may be received by input 103, and AWG DEMUX 301 may be configured to transmit the optical signal along a first axis (e.g., the x-axis). The optical signal may have multiple wavelengths of light or a single wavelength of light, and may carry data. The optical signal may be a modulated optical carrier signal. AWG DEMUX 301 may demultiplex the optical signal and output a plurality of optical signals with differing wavelengths. Each of the plurality of optical signals may include a single wavelength or a wavelength range. Photodiode 303 is configured to receive an optical signal from AWG DEMUX 301 at its photoactive area 304 and convert the optical signal into an electrical signal. The electrical signal is then output to TIA 206. The electrical signal may be an RF signal.

The electrical signal that TIA 206 receives may be a low impedance signal, such as a low impedance RF current signal, for example. TIA 206 may provide current to voltage conversion on the electrical signal it receives. For example, TIA 206 may receive a low impedance signal, such as a low impedance RF current signal, perform current to voltage conversion, and output a high impedance signal. The high impedance signal may be a high impedance RF voltage signal, for example.

Photodiode 303 may include a number of elements that help focus and/or direct optical signals to photoactive area 304. For example, photodiode 303 may include lenses, optical films, reflectors, or other optical elements that help focus and/or direct optical signals to photoactive area 304. By improving how optical signals are transmitted to photoactive area 304, the power of the optical signals may be increased, and the transmission efficiency may also therefore be increased. Photodiode 303 may be a surface mounted photodiode.

AWG DEMUX 301 may include an inclined end surface 302 configured to reflect the optical signal towards photodiode 303 at an obtuse angle of reflection θ₁ with respect to the first axis. The inclined end surface 302 may be inclined at an angle equal to θ₂ with respect to the first axis. For example, in one embodiment AWG DEMUX 301 may include inclined end surface 302 with an incline angle θ₂ equal to approximately 41 degrees. The obtuse angle of reflection θ₁ may provide for total reflection of the optical signal. Inclined end surface 302 may be a polished end surface. AWG DEMUX 301 may be mounted using a flip chip mounting method such that light impinges vertically (e.g., along y-axis) or substantially vertically onto the photoactive area 304 of photodiode 203 such that the RF signal path from photodiode 303 to output device 105 is minimized. The RF signal path may be a high frequency RF signal path because a reduced impedance may be present in the path, which allows for a higher frequency and speed of data transmission. A data rate of the data transmission may therefore be resistant to degradation during transmission. Moreover, the RF signal path may be resistant to distortion because distortion in the path may be limited.

The bending of light by angle of reflection θ₁ may be based on total reflection from the interface of two media with different refractive index according to Snell's law. For example, AWG DEMUX 301 may be made from SiO₂. Light may be bent from the SiO₂ to air interface as shown by FIG. 3 as long as the critical angle for total reflection is achieved. The light in AWG DEMUX 301 may be considered as a planar wave. The critical angle for total reflection can be calculated using Snell's law at the SiO₂ to air interface, using the following formula: θ_{1critical}=Arcsin(1×(Sin(90°))/n_{SiO2}), where n_{SiO2} may be 1.45.

Total reflection may occur if the incident angle is greater than the critical angle. Inclined end surface 302 may be polished such that the reflection it provides is almost vertical, yet slightly angled, such that back reflection is minimized. For example, in one embodiment, when inclined end surface 302 is has an angle θ₂ of approximately 41 degrees , the reflected light may be almost vertical yet slightly angled, and back reflection from photodiode 303 may be minimized or reduced.

For different waveguide materials, the ideal angle θ₂ of end surface 302 may be different. End surface 302 may be angled such that θ₂ is less than or equal to 90°−ArcSin [1×Sin(90°)/n_{WG}], where n_{WG} is the refractive index of the waveguide material of AWG DEMUX 301. Therefore, the maximum angle that θ₂ can be to still reflect light may be equal to 90°−ArcSin[1×Sin(90°)/n_{WG}]. The critical angle of AWG DEMUX 301 may equal ArcSin[1×Sin(90°)/n_{WG}].

To calculate angle of reflection θ₁, the angle θ₂ of end surface 302 may be considered. For example, angle of reflection θ₁ equals 90 degrees+(90 degrees−(2×θ₂)). Therefore, when end surface 302 has an incline angle θ₂ of 41 degrees, angle of reflection θ₁ equals 90 degrees+(90 degrees−(2×41)), which equals 98 degrees. Therefore, in this example, the angle of reflection θ₁ from the first axis is 98 degrees.

Since the divergence angle of the light exiting from AWG DEMUX 301 may be small, optical coupling efficiency may be insensitive to the gap (e.g., distance along the y-axis) between AWG DEMUX 301 and photodiode 203. Also, optimum coupling efficiency may be achieved by alignment in only two dimensions (e.g., along the plane formed by the z-axis and the x-axis). Thus, this approach may simplify the alignment process and also improve post alignment stability when the gap is preset by design.

Alignment of photodiode 203 with AWG DEMUX 301 may be achieved passively. For example, the alignment may be achieved without biasing photodiode 203 and/or light that is input into AWG DEMUX 301. Alignment may be performed using a precision alignment station, for example. The alignment can be performed using alignment patterns on one or both of AWG DEMUX 301 and photodiode 203.

FIG. 4 shows an optoelectronic receiver 400 in accordance with embodiments of the present disclosure. Optoelectronic receiver 400 may include an input 103, arrayed wave guide demultiplexer (AWG DEMUX) 201, photodiode 303, TIA 206, bench 207, reflector 401, and output device 105, which are housed by housing 101. Housing 101 is partially shown in FIG. 4 for ease of viewing.

An optical signal may be received by input 103, and AWG DEMUX 201 may be configured to transmit the optical signal along a first axis (e.g., the x-axis). The optical signal may have multiple wavelengths of light. Therefore, AWG DEMUX 201 may demultiplex the optical signal and output a plurality of optical signals with differing wavelengths. Optical signals output by AWG DEMUX 201 may be reflected by reflector 401. AWG DEMUX 201 may include anti-reflection (AR) coating on its surface that outputs optical signals to reflector 401. Reflector 401 may have an inclined surface configured to reflect an optical signal towards photoactive area 304 of photodiode 303 at an obtuse angle of reflection θ₃ with respect to the first axis. Reflector 401 may be a mirror. The inclined surface 402 of reflector 401 may be inclined at an angle θ₄ from the first axis.

The angle of reflection θ₃ equals 90 degrees+(90 degrees−(2×θ₄)). Therefore, when end surface 402 has and incline angle θ₄ of 41 degrees, angle of reflection θ₃ equals 90 degrees+(90 degrees−(2×41)), which equals 98 degrees. Therefore, in this example, the angle of reflection θ₃ from the first axis is 98 degrees.

Photodiode 303 is configured to receive, at photoactive area 304, a reflected optical signal from reflector 401 and convert the optical signal into an electrical signal. The electrical signal is then output to TIA 206. The electrical signal may be an RF signal.

The embodiment of FIG. 4 is similar to that of FIG. 3, except that instead of the AWG DEMUX having an inclined end surface, reflector 401 is included to reflect light. This configuration provides that the AWG DEMUX would not have to be specially designed or modified to have an inclined end surface, and a AWG DEMUX that does not have an inclined end surface may be used to implement receiver 400.

The embodiments of the present disclosure may process input optical signals that have varying wavelengths of light. For example, optical signals that are input via input 103 are preferred to have a wavelength in the range from 1270 nm to 1610 nm, for example.

The embodiments of the present disclosure may contemplate RF signals that have different data rates. For example, a data rate of an RF signal that is input into TIA 206 is preferred to be at or above 25 Gb/s, or at or below 40 Gb/s. The RF data rate may be based on a frequency response of photodiode 303 when it is illuminated, for example.

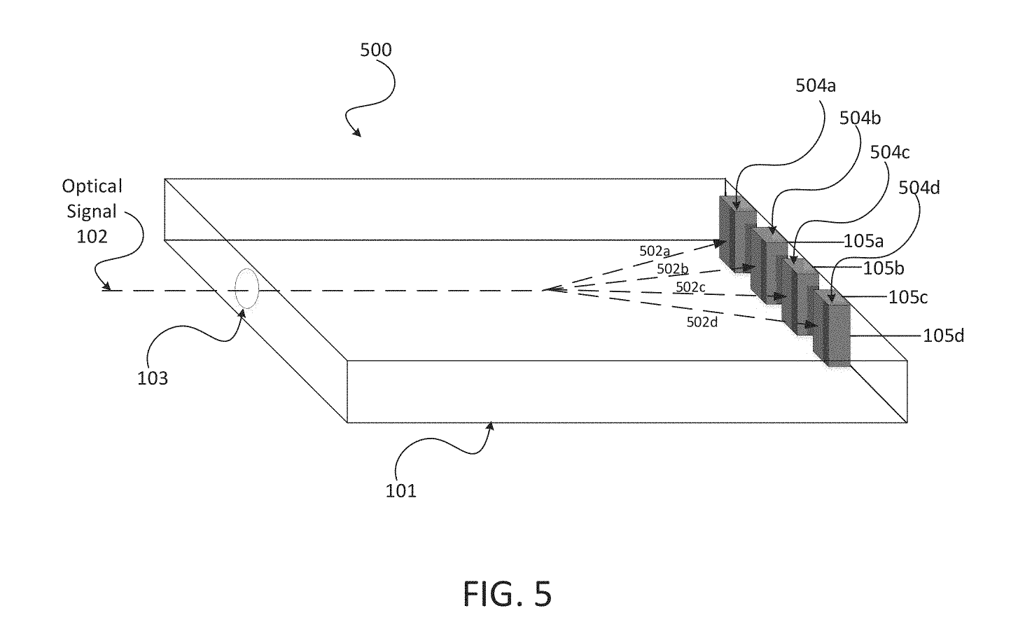

FIG. 5 shows an optoelectronic receiver 500 in accordance with embodiments of the present disclosure. Optoelectronic receiver 500 may be implemented as optoelectronic receiver 300 or 400, and shows how an input optical signal 102 may be demultiplexed by an AWG DEMUX to produce optical signals 502a, 502b, 502c, and 502d, which may each be optical signals with a different respective wavelength or different respective wavelength range. Optical signals 502a, 502b, 502c, and 502d may each be processed by devices 504a, 504b, 504c, and 504d, respectively. Each device 504 may include a photodiode, such as photodiode 303, and a TIA 206. Additionally, each device 504 may include a reflector, such as reflector 401. Each of devices 504a, 504b, 504c, and 504d is coupled to a respective output device 105a through 105d.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

1. An optoelectronic receiver comprising:
an optical signal demultiplexer configured to transmit an optical signal along a first axis; and
a photodiode configured to convert the optical signal into an electrical signal,
wherein the optical signal demultiplexer includes an inclined end surface configured to reflect the optical signal towards a photoactive area of the photodiode at an obtuse angle of reflection with respect to the first axis.

2. The optoelectronic receiver of claim 1, wherein the optical signal includes multiple wavelengths of light.

3. The optoelectronic receiver of claim 1, wherein the optical signal includes a single wavelength of light.

4. The optoelectronic receiver of claim 1, wherein the optical signal is a modulated optical carrier signal.

5. The optoelectronic receiver of claim 1, wherein the optical signal demultiplexer is configured to demultiplex the optical signal into a plurality of optical signals that each have a different wavelength of light.

6. The optoelectronic receiver of claim 1, wherein the photodiode is configured to convert the optical signal into a radio frequency (RF) signal.

7. The optoelectronic receiver of claim 6, wherein the RF signal is output via an RF feedthrough.

8. The optoelectronic receiver of claim 1, wherein the photodiode includes at least one lens configured to focus the optical signal toward the photoactive area of the photodiode.

9. The optoelectronic receiver of claim 1, wherein the optical signal demultiplexer is an arrayed waveguide demultiplexer.

10. The optoelectronic receiver of claim 1, wherein the obtuse angle of reflection is about 98 degrees.

11. The optoelectronic receiver of claim 1, wherein an angle of the inclined end surface is less than or equal to about 90°−ArcSin[1×Sin(90°)/n_{WG}], where n_{WG} is the refractive index of a waveguide material of the optical signal demultiplexer.

12. An optoelectronic receiver comprising:
an optical signal demultiplexer configured to transmit an optical signal along a first axis;
a photodiode configured to convert the optical signal into an electrical signal; and
a reflector having an inclined surface configured to reflect the optical signal towards a photoactive area of the photodiode at an obtuse angle of reflection with respect to the first axis.

13. The optoelectronic receiver of claim 12, wherein the optical signal includes multiple wavelengths of light.

14. The optoelectronic receiver of claim 12, wherein the optical signal includes a single wavelength of light.

15. The optoelectronic receiver of claim 12, wherein the optical signal is a modulated optical carrier signal.

16. The optoelectronic receiver of claim 12, wherein the optical signal demultiplexer is configured to demultiplex the optical signal into a plurality of optical signals that each have a different wavelength of light.

17. The optoelectronic receiver of claim 12, wherein the photodiode is configured to convert the optical signal into a radio frequency (RF) signal.

18. The optoelectronic receiver of claim 17, wherein the RF signal is output via an RF feedthrough.

19. The optoelectronic receiver of claim 12, wherein the photodiode includes at least one lens configured to focus the optical signal toward the photoactive area of the photodiode

20. The optoelectronic receiver of claim 12, wherein the optical signal demultiplexer is an arrayed waveguide demultiplexer.

21. The optoelectronic receiver of claim 12, wherein the obtuse angle of reflection is about 98 degrees.
